(19) United States
(12) Patent Application Publication
(10) Pub. No.: US 2019/0057047 A1
(43) Pub. Date: Feb. 21, 2019

(54) DATA STORAGE DEVICE AND A METHOD FOR CONTROLLING ACCESS TO A MEMORY DEVICE OF A DATA STORAGE DEVICE

(71) Applicant: MediaTek Singapore Pte. Ltd., Singapore (SG)

(72) Inventors: Steve Hengchen HSU, San Jose, CA (US); Po-Kai FAN, Hsinchu (TW); Yu-Yin CHEN, Hsinchu (TW)

(21) Appl. No.: 16/005,831

(22) Filed: Jun. 12, 2018

Related U.S. Application Data
(60) Provisional application No. 62/547,923, filed on Aug. 21, 2017.

(51) Int. Cl. G06F 13/16; G06F 13/18; G06F 13/372

(52) U.S. Cl. CPC G06F 13/1605; G06F 13/1689; G06F 13/372; G06F 13/18

(57) ABSTRACT

A data storage device coupled to a plurality of client devices, each being given a priority and an access quota, includes a memory device and an arbiter. The arbiter is configured to receive one or more access requests requesting to access the memory device from one or more client devices within a predetermined period of time, and arbitrate which client device gets the right to access the memory device based on the priorities and the access quotas of the corresponding client devices when there is more than one client device transmitting the access request at the same time.

### CROSS REFERENCE TO RELATED APPLICATIONS

This application claims the benefit of U.S. Provisional Application No. 62/547,923 filed 2017 Aug. 21 and entitled “Quota Based Vector Memory Arbitration Scheme”, the entire contents of which are hereby incorporated by reference.

### BACKGROUND OF THE INVENTION

### Field of the Invention

The invention relates to a data storage device and a method for controlling access to a memory device of a data storage device by using a quota-based arbitration scheme which can not only support sufficient throughputs for client devices that require consistent quality of service, but also avoid wasting memory-access opportunities.

### Description of the Related Art

Memory controllers are frequently utilized in processing systems to control access to memory resources for multiple client devices seeking to store data to memory or to access data from memory. The arbitration scheme should support sufficient throughputs for the client devices that require consistent quality of service. In addition, the arbitration scheme should also avoid wasting memory-access opportunities.

There are various memory arbitration schemes in conventional system designs. These include the static fixed priority scheme and the Time-Division-Multiplex (TDM) scheme. Regarding the conventional static fixed priority scheme, memory access requests are supplied to a memory controller based on certain fixed priorities. The merits of the static fixed priority scheme are simple, easy to implement, and low cost. In addition, there are no system-introduced inefficiencies such as access slot wasted. However, the selection for memory access requests based solely on a fixed prioritization scheme often can introduce significant penalties in quality of service. A low-priority client device might not get enough throughputs (grants) in time. Therefore, quality of service/throughput is not guaranteed.

On the other hand, each client device is assigned with a certain number of access-slots within a period of time, using the conventional TDM scheme. Therefore, the throughput requirement of each client device would be met. However, there will be system-introduced inefficiencies if the designated client device did not use the assigned slots. In addition, timing synchronization would be crucial because all the client devices should know this information and send out requests at their own time slots.

In order to solve the problems illustrated above, a quota-based memory arbitration scheme is provided, which can not only support sufficient throughputs for the client devices that require consistent quality of service, but also avoid wasting memory-access opportunities.

### BRIEF SUMMARY OF THE INVENTION

Data storage devices and methods for controlling access to a memory device of a data storage device are provided. An exemplary embodiment of a data storage device coupled to a plurality of client devices comprises a memory device and an arbiter. Each client device is given a priority and an access quota. The arbiter is configured to receive one or more access requests requesting to access the memory device from one or more client devices within a predetermined period of time, and arbitrate which client device gets the right to access the memory device based on the priorities and the access quotas of the corresponding client devices when there is more than one client device transmitting the access request at the same time.

An exemplary embodiment of a method for controlling access to a memory device of a data storage device coupled to a plurality of client devices, wherein each client device is given a priority and an access quota, comprises: receiving one or more access requests requesting to access the memory device from one or more client devices within a predetermined period of time; and arbitrating which client device gets the right to access the memory device based on the priorities and the access quotas of the corresponding client devices when there is more than one client device transmitting the access request at the same time.

Another exemplary embodiment of a data storage device coupled to a plurality of client devices comprises a memory device and an arbiter. Each client device is given a fixed priority and an access quota. The arbiter is configured to receive one or more access requests requesting to access the memory device from one or more client devices within a predetermined period of time, dynamically determine a run-time priority for the one or more client devices transmitting the access request according to the corresponding fixed priorities and the access quotas, and arbitrate which client device gets the right to access the memory device based on the run-time priorities of the corresponding client devices when there is more than one client device transmitting the access request at the same time.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is an exemplary block diagram of an electronic device according to an embodiment of the invention;

FIG. 2 is a flow chart of a method for controlling access to a memory device of a data storage device by using the proposed quota-based arbitration scheme according to an embodiment of the invention;

FIG. 3 is a schematic diagram showing a priority change example according to an embodiment of the invention; and

FIG. 4 is a schematic diagram showing an exemplary circuit diagram of a portion of the hardware devices inside of the arbiter 140 for implementing the proposed quota-based arbitration scheme according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As discussed above, regarding the conventional static fixed priority scheme, quality of service/throughput is not guaranteed. On the other hand, regarding the conventional TDM scheme, there will be system-introduced inefficiencies if the designated client device did not use the assigned slots. In addition, timing synchronization is crucial because all the client devices should know this information and send out requests at their own time slots.

To solve the problems as illustrated above, in the following paragraphs, a quota-based memory arbitration scheme is provided, which can not only support sufficient throughputs for the client devices that require consistent quality of service, but also avoid wasting memory-access opportunities.

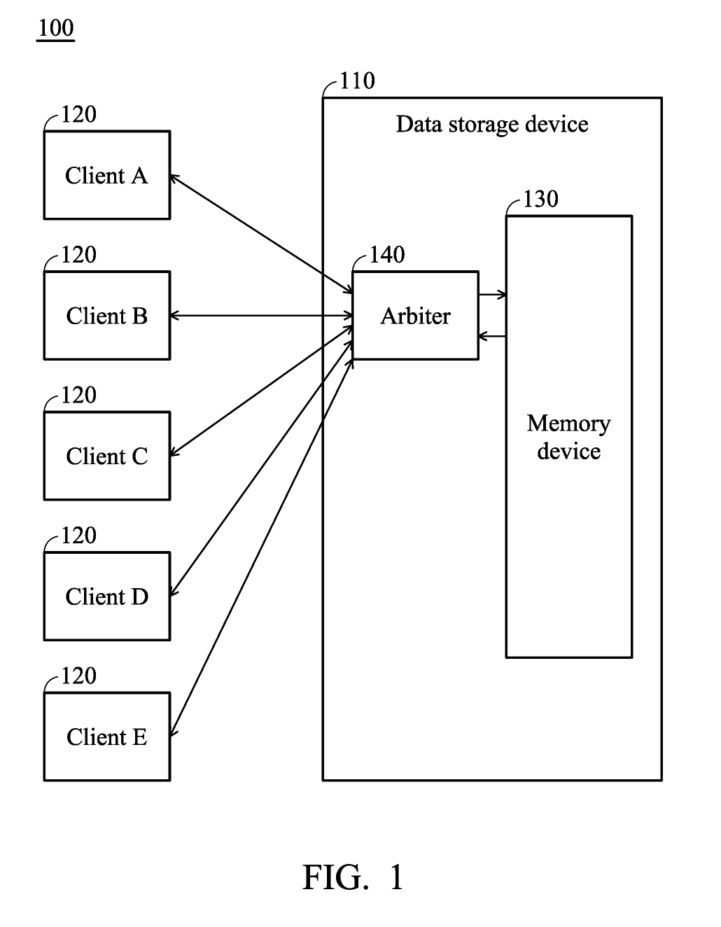

FIG. 1 is an exemplary block diagram of an electronic device according to an embodiment of the invention. The electronic device 100 may comprise a data storage device 110 and a plurality of client devices 120, such as the Clients A˜E, coupled to the data storage device 110. The data storage device 110 may comprise a memory device 130 and an arbiter 140. The client device 120 may be any type of hardware device that has the need to read data from or write data into the memory device 130. As an example, the client A may be a Digital Signal Processor (DSP), the client B may be an Analog to Digital Converter (ADC), the client C may be a modulator, and so on.

The memory device 130 may be any type of memory device, such as a flash memory, a random access memory, etc. The arbiter 140 may be configured to receive one or more access requests requesting to access the memory device 130 from one or more client devices 120. According to an embodiment of the invention, the memory device 130 may be provided as a data exchange medium for the client devices 120 to exchange data.

According to an embodiment of the invention, each client device 120 is given a priority and an access quota. The arbiter 140 may be configured to arbitrate which client device 120 gets the right to access the memory device 130 based on the priorities and the access quotas of the corresponding client devices 120 when there is more than one client device 120 transmitting the access request at the same time.

According to an embodiment of the invention, the arbiter 140 may receive a clock signal and may be triggered by the clock pulses of the clock signal to perform the arbitration. The duration between the rising/falling edges of two successive clock pulses may be regarded as one clock cycle or one time-slot. In an embodiment of the invention, the arbiter 140 may collect the access requests received within one clock cycle, and perform the arbitration before or at the rising/falling edge of a clock pulse, so as to determine which client device 120 gets the right to access the memory device 130 in a next clock cycle. Therefore, in the embodiments of the invention, the term “at the same time” may refer to “within one clock cycle”, “within one time-slot”, “before the rising/falling edge of one clock pulse”, and so on.

In the proposed quota-based arbitration system, each client device will be evaluated into two tiers of priorities. To be more specific, according to an embodiment of the invention, the arbiter 140 may be configured to dynamically group the client devices 120 into two tiers of client groups. Since the client devices are dynamically grouped, and the grouping of the client devices 120 may vary with time. For example, the grouping of the client devices 120 may be different in different clock cycles.

According to an embodiment of the invention, during an arbitration process, arbitration of the client devices belonging to a first tier of client groups is conducted prior to arbitration of the client devices belonging to a second tier of client groups.

To be more specific, in an embodiment of the invention, at the beginning of a predetermined period of time, all client devices 120 are grouped into (that is, belonging to) the first tier of client groups. The predetermined period of time may last for several clock cycles. As an example, in an embodiment of the invention, the predetermined period of time as discussed above may comprise 128 clock cycles.

According to an embodiment of the invention, in the first tier of client groups, the client devices have not used up their access quotas. In an embodiment of the invention, the first tier of client groups may also be regarded as a foreground client group. If the number of granted time-slots of one client device is greater than or equal to its access quota, this client device will be grouped into (that is, moved to) the second tier of client groups. In an embodiment of the invention, the second tier of client groups may also be regarded as a background client group.

According to an embodiment of the invention, the arbiter 140 may be configured to evaluate which tier of client groups the client device transmitting the access request should belong to according to the access quota initially assigned or given to this client device and the number of used time-slots of the client device. The number of used time-slots is an accumulated number for counding the total number of time-slots in which this client device is granted access to the memory device 130 within the predetermined period of time.

For example, suppose a client device Client A is initially given or assigned a priority P1(A) and an access quota Q(A), where the priority P1(A) is a fixed priority. The arbiter 140 may keep accumulating the total number of time-slots in which Client A is granted access to the memory device 130 within a predetermined period of time, and record the accumulation result as the number of used time-slots TS_used(A) of the client device Client A. According to an embodiment of the invention, when the number of used time-slots TS_used(A) of the client device Client A does not exceed the assigned access quota Q(A) of the client device Client A, which means the client device Client A has not used up its access quota Q(A). In this manner, the client device Client A still resides in the first tier of client groups. On the other hand, when the number of used time-slots TS_used(A) of the Client A exceeds the assigned access quota Q(A) of the client device Client A, the client device Client A is grouped into the second tier of client groups.

According to an embodiment of the invention, at the beginning (or the end) of the predetermined period of time, the number of used time-slots of each client device may be reset to 0. That is, the number of used time-slots TS_used of each client device will be recorded by the arbiter 140 and will be refreshed at the beginning (or the end) of every predetermined period of time.

According to an embodiment of the invention, the priority P1 of a client device may be determined based on the memory access flexibility, the arbitration sensitivity and/or the tolerance of access latency of the client device. For example, the client device with lower memory access flexibility may be a given higher priority because if the memory access requirement cannot be fulfilled, the current operations of the client device will fail more easily for the client device with lower memory access flexibility. In another example, the client device with lower arbitration sensitivity may be given a lower priority because if the client device cannot get the right to use the memory device 130, there may be a secondary choice for the client device to use its internal buffer instead. In another example, the client device with lower tolerance of access latency of the client device may be given a higher priority.

In addition, according to an embodiment of the invention, the access quota Q may be determined based on a statistic result of the number of requested time-slots previously requested by the client devices within one predetermined period of time and/or the throughput requirements of the client devices. According to an embodiment of the invention, the priority P1 and the access quota Q of each client device may be predetermined in the designing phase of the electronic device and the priority P1 and the access quota Q may be static parameters utilized in quota-based arbitration scheme.

As discussed above, in the proposed quota-based arbitration scheme, during an arbitration process, arbitration of the client devices belonging to a first tier of client groups is conducted prior to arbitration of the client devices belonging to a second tier of client groups. To be more specific, according to an embodiment of the invention, during the arbitration process, the arbiter 140 may be configured to determine which client device in the first tier of client groups gets the right to access the memory device 130, first, based on the priorities of the client devices which transmitting the access request. The client device in the first tier of client groups having the highest priority among all the tier-one requesters will get the right to access the memory device 130. That is, the client device with higher priority in the first tier of client groups will be served earlier than the others.

If there is no request from the first tier of client groups or when there is no client device in the first tier of client groups gets the right to access the memory device 130, the arbiter 140 may then be configured to determine which client device in the second tier of client groups gets the right to access the memory device 130 based on the priorities of the client devices which transmitting the access request. The client device in the second tier of client groups having the highest priority among all the tier-two requesters will get the right to access the memory device 130.

Eventually, the throughput requirement of each client device will be met because the unsatisfied client device will remain in the first tier of client groups while those clients who get enough grants would be moved to the second tier of client groups. Unlike the TDM scheme, there won't be system-introduced inefficiencies.

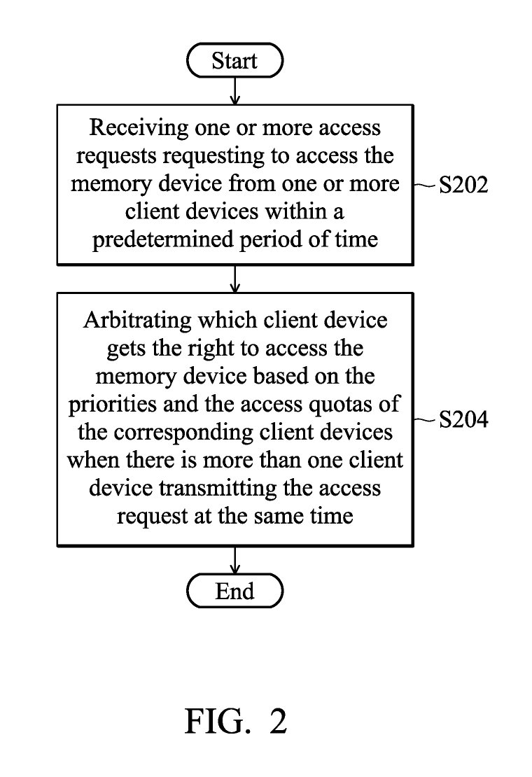

FIG. 2 is a flow chart of a method for controlling access to a memory device of a data storage device by using the proposed quota-based arbitration scheme according to an embodiment of the invention. First of all, the arbiter 140 receives (or, collects) one or more access requests requesting to access the memory device from one or more client devices within a predetermined period of time (Step S202). Next, the arbiter 140 arbitrates which client device gets the right to access the memory device based on the priorities and the access quotas of the corresponding client devices when there is more than one client device transmitting the access request at the same time (Step S204).

According to an embodiment of the invention, when implementing the proposed quota-based arbitration scheme, the arbiter 140 may further dynamically determine a run-time priority P2 for the one or more client devices transmitting the access request according to the corresponding fixed priorities P1, the access quotas Q and the number of used time-slots TS_used, and arbitrate which client device gets the right to access the memory device based on the run-time priority P2 of the corresponding client devices when there is more than one client device transmitting the access request at the same time.

According to an embodiment of the invention, at any particular time slot, by dynamically determining the run-time priority P2, the implementation of the two-tier arbitration can still be regarded as combining the first tier of client groups and second tier of client groups arbitrations as one simple priority-scheme, and the implementation of the two-tier arbitration would be similar to one particular priority assignment that is varying according to the number of used time-slots among all the client devices.

According to an embodiment of the invention, the arbiter 140 is configured to determine the run-time priority of a client device according to the originally assigned priority P1 (fixed priority), the assigned access quota Q, the number of used time-slots TS_used of the client device. If the priority number system is defined as lowest number represents highest priority, when the number of used time-slots TS_used of one client device exceeds the access quota Q thereof, the arbiter 140 is configured to add a predetermined number N to the fixed priority P1 of the client device to obtain the run-time priority P2 of the client device. For example, P2=P1+N, where N may be a positive integer equal to the total number of client devices in the system and the fixed priority P1 may belong to [0:N−1]. Therefore, the implementation would be similar to one simple priority scheme with priority assigned from 0 to (2N−1).

In addition, during the arbitration process, the arbiter 140 may dynamically group the client devices into a first tier of client groups or a second tier of client groups according to the run-time priorities P2 of the client devices. For example, when the run-time priority P2(A) of the client device Client A is not greater than the predetermined number N, the client device Client A still resides in the first tier of client groups, and when the run-time priority P2(A) of the client device Client A is greater than the predetermined number N, the client device Client A is moved to the second tier of client groups.

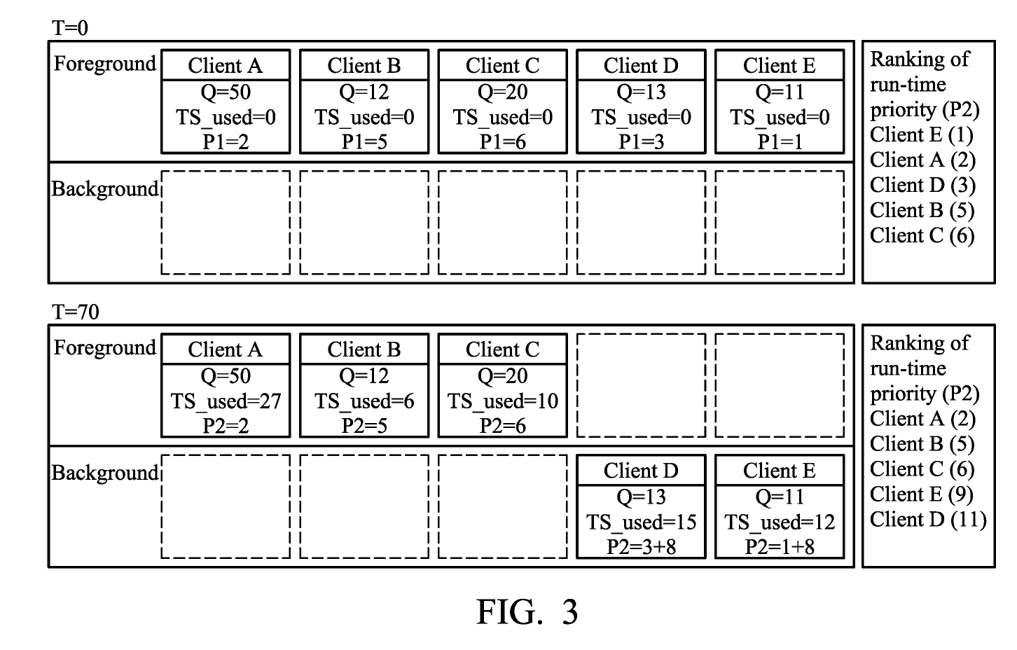

FIG. 3 is a schematic diagram showing a priority change example according to an embodiment of the invention. As shown in FIG. 3, initially, at the time slot 0 (T=0), all the client devices belong to the foreground client group. The assigned priority P1 of the client device Client A is 2, the assigned access quota Q of the client device Client A is 50, and the number of used time-slots TS_used of the client device Client A is 0. The assigned priority P1 of the client device Client B is 5, the assigned access quota Q of the client device Client B is 12, and the number of used time-slots TS_used of the client device Client B is 0. The assigned priority P1 of the client device Client C is 6, the assigned access quota Q of the client device Client C is 20, and the number of used time-slots TS_used of the client device Client C is 0. The assigned priority P1 of the client device Client D is 3, the assigned access quota Q of the client device Client D is 13, and the number of used time-slots TS_used of the client device Client D is 0. The assigned priority P1 of the client device Client E is 1, the assigned access quota Q of the client device Client E is 11, and the number of used time-slots TS_used of the client device Client E is 0.

Therefore, at the time slot 0 (T=0), the run-time priority P2 of each client device equals to the initially assigned priority P1 thereof, and the ranking of run-time priorities P2 of the client devices would be Client E>Client A>Client D>Client B>Client C.

After some period of time, for example, at the time slot 70 (T=70), because the client devices Client D and Client E have used up their access quotas, the run-time priority P2 thereof will be changed by adding a predetermined number, such as 8 in this example. Therefore, at the time slot 70 (T=70), the ranking of run-time priorities P2 of the client devices would become Client A>Client B>Client C>Client E>Client D. In this manner, only the client devices Client A, Client B and Client C belong to the foreground client group and the client devices Client D and Client E are moved to the background client group. Therefore, at the time slot 70 (T=70), serving of the client devices Client A, Client B and Client C in the foreground client group will be conducted prior to the client devices Client D and Client E in the background client group.

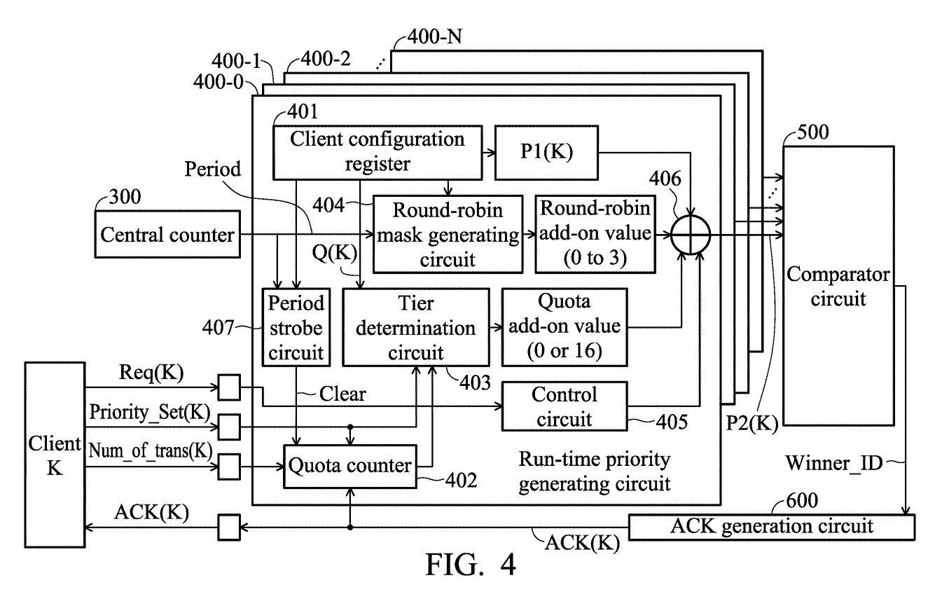

FIG. 4 is a schematic diagram showing an exemplary circuit diagram of a portion of the hardware devices inside of the arbiter 140 for implementing the proposed quota-based arbitration scheme according to an embodiment of the invention. The hardware devices inside of the arbiter 140 for implementing the proposed quota-based arbitration scheme may at least comprise a central counter 300, a plurality of run-time priority generating circuits 400-0˜400-N, a comparator circuit 500 and an ACK generation circuit 600. According to an embodiment of the invention, one client device may be provided with one run-time priority generating circuit. Therefore, when there are N client devices in the whole system that would transmit access requests requesting to access the memory device 130, at least N run-time priority generating circuits will be provided.

Suppose that the client device Client K is coupled to the run-time priority generating circuit 400-0. The client device Client K may transmit the access request Req(K) and the number of transactions Num_of_trans(K) to the arbiter 140. The access request Req(K) may be one bit data, that is, 0 or 1, where 1 may indicate that client device Client K requests to access the memory device 130 in a next clock cycle. The number of transactions Num_of_trans(K) may be a positive integer indicating the number of time slots request by the client device Client K to access the memory device 130.

In addition, according to an embodiment of the invention, the client device Client K may further transmit a priority setting value Priority_Set(K) to the arbiter 140. The priority setting value Priority_Set(K) may be one bit data, that is, 0 or 1, where 0 may indicate that client device Client K request to move itself to the background client group, voluntarily.

The client configuration register 401 may be a register configured to provide the static parameters required for arbitration. For example, the configuration register 401 may provide the fixed priority P1(K) of the client device Client K, the assigned access quota Q(K) of the client device Client K and the length setting of the predetermined period of time Period. The quota counter 402 is configured to accumulate the total number of time-slots TS_used(K) in which this client device Client K is granted access to the memory device 130 within a predetermined period of time, and provide the accumulation result to the tier determination circuit 403. The tier determination circuit 403 may receive the assigned access quota Q(K) from the client configuration register 401 and receive the accumulation result from the quota counter 402, compare the number of used time-slots TS_used(K) with the assigned access quota Q(K) to determine whether the client device Client K has used up its access quota. The tier determination circuit 403 may output a quota add-on value based on the comparison result. For example, when the client device Client K has not used up its access quota, the tier determination circuit 403 may output the quota add-on value as 0, while when the client device Client K has used up its access quota, the tier determination circuit 403 may output the quota add-on value as 16 (that is, the predetermined number as discussed above).

According to an embodiment of the invention, the run-time priority generating circuit 400-0 may further comprise a round-robin mask generating circuit 404. The round-robin mask generating circuit 404 may be enabled when there is more than one client device given the same priority, so as to make these client devices distinguishable. For example, suppose that the DSP circuit may be divided into four individual clients. However, since these four clients are all belong to the DSP circuit, they may be assigned with the same priority. The round-robin mask generating circuit 404 is configured to output a random number, that is, the Round-robin add-on value, based on the output of the central counter 300. According to an embodiment of the invention, the central counter 300 is configured to keep counting according to the clock signal. In this embodiment, the round-robin mask generating circuit 404 may divide the output of the central counter 300 by 4, and take the remainder thereof as the Round-robin add-on value. Therefore, in this embodiment, the Round-robin add-on value may be 0, 1, 2 or 3.

Note that in the embodiments of the invention, the round-robin mask generating circuit 404 is an optional choice. That is, when there is no client device given the same priority, the round-robin mask generating circuit 404 may be disabled. The enablement or disablement of the round-robin mask generating circuit 404 may be controlled by the output of the client configuration register 401.

The run-time priority generating circuit 400-0 may further comprise an adder circuit 406. The adder circuit 406 is configured to collect the parameters comprising the fixed priority P1(K), the Round-robin add-on value and quota add-on value, and output a summation thereof as the run-time priority P2(K) of the client device Client K. The operation of the adder circuit 406 may be enabled or disabled by the control circuit 405. The control circuit 405 may receive the access request Req(K) of the device Client K and may enable the adder circuit 406 when Req(K)=1.

The comparator circuit 500 may collect the run-time priority P2(K) of the client devices, and determine the winner client device. The comparator circuit 500 may output the ID of the winner client device having the highest priority among all the client devices. For example, suppose the client device Client K have the highest priority among all the client devices (e.g. the value of P2(K) is the smallest one), the comparator circuit 500 may output the ID of the client device Client K to the ACK generation circuit 600. The ACK generation circuit 600 may generate the acknowledgement signal ACK(K) for the client device Client K.

Note that in the embodiments of the invention, besides the requested number of transactions Num_of_trans(K), the quota counter 402 may further receive the acknowledgement signal ACK(K) and the priority setting value Priority_Set(K) of the client device Client K, and determine whether to accumulate the current requested number of transactions Num_of_trans(K) into the number of used time-slots TS_used(K). For example, when the acknowledgement signal ACK(K) indicates that the request of the client device Client K is not granted, the current requested number of transactions Num_of_trans(K) will not be added into the number of used time-slots TS_used(K). In another example, when the priority setting value Priority_Set(K) of the client device Client K indicate that client device Client K request to move itself in the background client group, the current requested number of transactions Num_of_trans(K) will not be added into the number of used time-slots TS_used(K).

In addition, the quota counter 402 may further receive the clear signal Clear from the period strobe circuit 407. The period strobe circuit 407 may receive the length setting of the predetermined period of time Period from the client configuration register 401 and generate the clear signal Clear when the predetermined period of time Period expires. In response to the assertion of the clear signal Clear, the number of used time-slots TS_used of the corresponding client device will be refreshed and reset to 0.

As discussed above, in the proposed quota-based arbitration scheme, the arbiter 140 will first give the grant to one of the tier-one client devices that do not use up all the quotas and is assigned with highest priority. If there is no tier-one client device sending request, the arbiter 140 will give the grant to one of the tier-two client devices according to the ranking of their priorities. By using the proposed quota-based memory arbitration scheme, not only sufficient throughputs can be supported for the client devices that require consistent quality of service, but also wasting of the memory access opportunities can be avoided.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data storage device, coupled to a plurality of client devices, wherein each client device is given a priority and an access quota, and the data storage device comprises:
a memory device; and
an arbiter, configured to receive one or more access requests requesting to access the memory device from one or more client devices within a predetermined period of time, and arbitrate which client device gets the right to access the memory device based on the priorities and the access quotas of the corresponding client devices when there is more than one client device transmitting the access request at the same time.

2. The data storage device as claimed in claim 1, wherein the arbiter is further configured to dynamically group the client devices into two tiers of client groups, and during an arbitration process, arbitration of the client devices belonging to a first tier of client groups is conducted prior to arbitration of the client devices belonging to a second tier of client groups.

3. The data storage device as claimed in claim 2, wherein at the beginning of the predetermined period of time, all client devices are grouped into the first tier of client groups.

4. The data storage device as claimed in claim 2, wherein the arbiter is further configured to evaluate which tier of client groups the client device transmitting the access request should belong to according to the access quota and a number of used time-slots of the client device, and wherein the number of used time-slots is a total number of time-slots in which the client device is granted access to the memory device within the predetermined period of time.

5. The data storage device as claimed in claim 4, wherein at the beginning of the predetermined period of time, the number of used time-slots of each client device is reset to 0.

6. The data storage device as claimed in claim 4, wherein when the number of used time-slots of one client device does not exceed the access quota thereof, the client device is grouped into the first tier of client groups, and when the number of used time-slots of one client device exceeds the access quota thereof, the client device is grouped into the second tier of client groups.

7. A method for controlling access to a memory device of a data storage device coupled to a plurality of client devices, wherein each client device is given a priority and an access quota, and the method comprises:
receiving one or more access requests requesting to access the memory device from one or more client devices within a predetermined period of time; and
arbitrating which client device gets the right to access the memory device based on the priorities and the access quotas of the corresponding client devices when there is more than one client device transmitting the access request at the same time.

8. The method as claimed in claim 7, further comprising:
dynamically grouping the client devices into two tiers of client groups,
wherein during an arbitration process, arbitration of the client devices belonging to a first tier of client groups is conducted prior to arbitration of the client devices belonging to a second tier of client groups.

9. The method as claimed in claim 8, wherein at the beginning of the predetermined period of time, all client devices are grouped into the first tier of client groups.

10. The method as claimed in claim 8, further comprising:
evaluating which tier of client groups the client device transmitting the access request should belong to according to the access quota and a number of used time-slots of the client device,
wherein the number of used time-slots is a total number of time-slots in which the client device is granted access to the memory device within the predetermined period of time.

11. The method as claimed in claim 10, wherein at the beginning of the predetermined period of time, the number of used time-slots of each client device is reset to 0.

12. The method as claimed in claim 10, wherein when the number of used time-slots of one client device does not exceed the access quota thereof, the client device is grouped into the first tier of client groups, and when the number of used time-slots of one client device exceeds the access quota thereof, the client device is grouped into the second tier of client groups.

13. A data storage device, coupled to a plurality of client devices, wherein each client device is given a fixed priority and an access quota, the data storage device comprising:
a memory device; and
an arbiter, configured to receive one or more access requests requesting to access the memory device from one or more client devices within a predetermined period of time, dynamically determine a run-time priority for the one or more client devices transmitting the access request according to the corresponding fixed priorities and the access quotas, and arbitrate which client device gets the right to access the memory device based on the run-time priorities of the corresponding client devices when there is more than one client device transmitting the access request at the same time.

14. The data storage device as claimed in claim 13, wherein the arbiter is further configured to dynamically group the client devices into two tiers of client groups according to the run-time priorities thereof, and during an arbitration process, arbitration of the client devices belonging to a first tier of client groups is conducted prior to arbitration of the client devices belonging to a second tier of client groups.

15. The data storage device as claimed in claim 14, wherein when the run-time priority of a client device is not greater than a predetermined number, the client device is grouped into the first tier of client groups, and when the run-time priority of the client device is greater than the predetermined number, the client device is grouped into the second tier of client groups.

16. The data storage device as claimed in claim 14, wherein at the beginning of the predetermined period of time, all client devices are grouped into the first tier of client groups.

17. The data storage device as claimed in claim 13, wherein the arbiter is configured to determine the run-time priority further according to a number of used time-slots of the client device, and wherein the number of used time-slots is a total number of time-slot(s) in which the client device is granted access to the memory device within the predetermined period of time.

18. The data storage device as claimed in claim 17, wherein when the number of used time-slots of one client device exceeds the access quota thereof, the arbiter is configured to add a predetermined number to the fixed priority of the client device to obtain the run-time priority of the client device.
